(19) United States
(12) Patent Application Publication
(10) Pub. No.: US 2024/0027185 A1
(43) Pub. Date: Jan. 25, 2024

(54) METHOD FOR MEASURING THICKNESS OF A THIN FILM LAYER ON GLASS

(71) Applicant: National Chung Cheng University, Minsyong Township (TW)

(72) Inventors: Hsiang-Chen Wang, Minsyong Township (TW); Yu-Yang Chen, Minsyong Township (TW); Yu-Ming Tsao, Minsyong Township (TW); Yu-Lin Liu, Minsyong Township (TW); Ching-Yi Huang, Minsyong Township (TW)

(73) Assignee: National Chung Cheng University, Minsyong Township (TW)

(21) Appl. No.: 17/974,676

(22) Filed: Oct. 27, 2022

(30) Foreign Application Priority Data
Jul. 21, 2022 (TW) 111127388

(51) Int. Cl. G01B 11/06; G06T 7/60

(52) U.S. Cl. CPC G01B 11/0616; G06T 7/60

(57) ABSTRACT

A method for measuring a thickness of a thin film layer disposed on a piece of glass is implemented using a computer device that stores a thin film image of the thin film layer, a surface dataset associated with a surface of the thin film layer, and a plurality of reference parameter sets each being associated with a specific thickness of the thin film layer, the method including: generating a spectral image dataset that includes spectral data associated with different pixels of the thin film image using a spectral transformation matrix; performing regression analysis on the surface dataset and the spectral image dataset, so as to obtain a thickness parameter set including a plurality of thickness parameters; and determining a thickness of the thin film layer using the thickness parameter set and the plurality of reference parameter sets.

### CROSS-REFERENCE TO RELATED APPLICATION

This application claims priority to Taiwanese Patent Application No. 111127388, filed on Jul. 21, 2022.

### FIELD

The disclosure relates to a method for measuring thickness of a thin film layer, and more particularly to a method for measuring thickness of a thin film layer on glass.

### BACKGROUND

Glass has a wide variety of applications in different fields (e.g., household uses, electronic devices, industrial uses, vehicular uses, etc.), and may be further processed to obtain additional functionalities and/or effects. For example, heat-reflecting glass may be manufactured by forming a thin film layer of a specific material on the surface of a piece of transparent glass. In use, the thin film layer is capable of absorbing and/or reflecting solar heat. Additionally, different materials and different thicknesses of the thin film layer may make the glass with the thin film layer have different functionalities such as anti-oxidation, anti-corrosion, heat-resistance, etc.

It is noted that the thickness of the thin film layer may be measured using an invasive method or a non-invasive method. The invasive method involves cutting through the thin film layer and employing an optical microscope to determine the thickness of the thin film layer. The non-invasive method involves manual measurement or using a spectrometer to determine the thickness of the thin film layer based on a specific refractive index of the material of the thin film layer.

### SUMMARY

One object of the disclosure is to provide a method that is capable of measuring thickness of a thin film layer disposed on a piece of glass.

According to one embodiment of the disclosure, the method is implemented using a computer device that includes a processor and a data storage medium storing a thin film image of the thin film layer taken by a camera, a surface dataset related to a surface of the thin film layer, and a plurality of reference parameter sets each being related to a specific thin film layer thickness. The method comprising following steps:
A) generating a spectral image dataset that includes a plurality of entries of spectral data based on the thin film image of the thin film layer using a spectral transformation matrix, each of the entries of spectral data being related to a spectrum of a respective one of pixels of the thin film image;
B) performing regression analysis on the surface dataset and the spectral image dataset, so as to obtain a thickness parameter set including a plurality of thickness parameters; and
C) determining the thickness of the thin film layer using the thickness parameter set and the plurality of reference parameter sets.

### BRIEF DESCRIPTION OF THE DRAWINGS

Other features and advantages of the disclosure will become apparent in the following detailed description of the embodiments with reference to the accompanying drawings. It is noted that various features may not be drawn to scale.

FIG. 1 is a block diagram illustrating a computer device for implementing a method for measuring thickness of a thin film layer on a piece of glass according to one embodiment of the disclosure.

FIG. 2 is a flow chart illustrating steps of a matrix calculating process of the method according to one embodiment of the disclosure.

FIG. 3 is a flow chart illustrating operations for obtaining a spectral transformation matrix according to one embodiment of the disclosure.

FIG. 4 is a flow chart illustrating steps of the measurement process of the method according to one embodiment of the disclosure.

FIG. 5 is a flow chart illustrating operations for generating a spectral image dataset based on a thin film image of the thin film layer, using the spectral transformation matrix.

FIG. 6 is a flow chart illustrating operations for determining thickness of the thin film layer disposed on the piece of glass.

FIG. 7 is a plot illustrating a number of data points of reference parameter sets scattered thereon.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

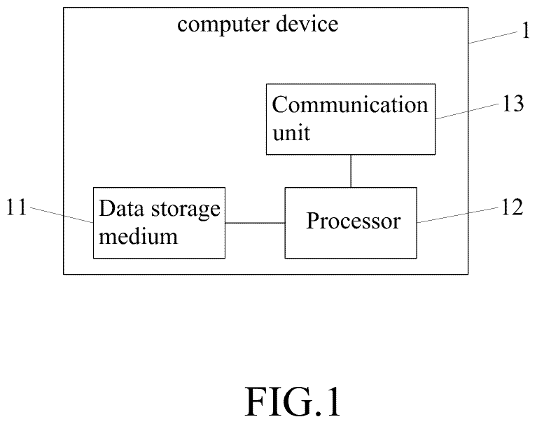

FIG. 1 is a block diagram illustrating a computer device 1 according to one embodiment of the disclosure. In this embodiment, the computer device 1 may be embodied using one of a server device, a personal computer, a laptop, a tablet, a mobile device, etc. The computer device 1 includes a data storage medium 11, a processor 12, and a communication unit 13.

The processor 12 may include, but not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc.

The communication unit 13 is connected to the processor 12, and may include at least one of a radio-frequency integrated circuit (RFIC), a short-range wireless communication module supporting a short-range wireless communication network using a wireless technology of Bluetooth® and/or Wi-Fi, etc., or a mobile communication module supporting telecommunication using Long-Term Evolution (LTE), the third generation (3G) and/or fifth generation (5G) of wireless mobile telecommunications technology, and/or the like.

The data storage medium 11 is connected to the processor 12, and may be embodied using computer-readable storage medium such as hard disk drive(s), random access memory (RAM), read only memory (ROM), programmable ROM (PROM), firmware, flash memory, etc.

In this embodiment, the data storage medium 11 stores a software application program, a reference color image of a reference object that is taken by a camera, an object spectral dataset that is related to the reference object, a thin film image of a thin film layer on a piece of glass that is taken by the camera, a surface dataset that is related to a surface of the thin film layer, and a plurality of reference parameter sets each being related to a specific thin film thickness. For example, the thin film layer is a coating applied to the piece of glass.

The reference object may be X-Rite ColorChecker® Classic, which includes twenty-four color squares with twenty-four common natural colors (e.g., blue, green, red, grey), respectively. The camera used for capturing the reference color image and the thin film image may be embodied using, for example, a DFK 33UX265 manufactured by The Imaging Source in this embodiment. The thin film image in this embodiment is stored as an image with a resolution of 800*600 pixels.

The object spectral dataset may include spectral data related to a spectrum of light reflected by the reference object and measured by, for example, a spectrometer. The spectrometer may be embodied using, for example, Ocean Optics QE65000 Spectrometer. In this embodiment, the object spectral dataset is obtained by the spectrometer measuring visible light with a wavelength ranging from 380 nanometers to 780 nanometers, resulting in spectral data with a spectral resolution of 1 nanometer. It is noted that in other embodiments, the object spectral dataset may be obtained by the spectrometer measuring other parts of spectrum, such as infrared light with a wavelength ranging from 900 nanometers to 1000 nanometers, resulting in spectral data with a spectral resolution of 1 nanometer.

The surface dataset may be obtained using a profilometer measuring the surface of the thin film layer. The profilometer may be embodied using, for example, a D300 profiler manufactured by KLA Corporation.

In some embodiments, the object spectral dataset may be obtained from the public resources provided by the Munsell Color Science Laboratory of Rochester Institute of Technology (RIT).

The software application program includes instructions that, when executed by the processor 12, cause the processor 12 to perform a number of operations as described in the subsequent paragraphs.

In use, it may be desired to measure the thickness of the thin film layer on the piece of glass, using the thin film image.

According to one embodiment of the disclosure, a method for measuring thickness of a thin film layer on a piece of glass is provided. The method may include a matrix calculating process and a measurement process.

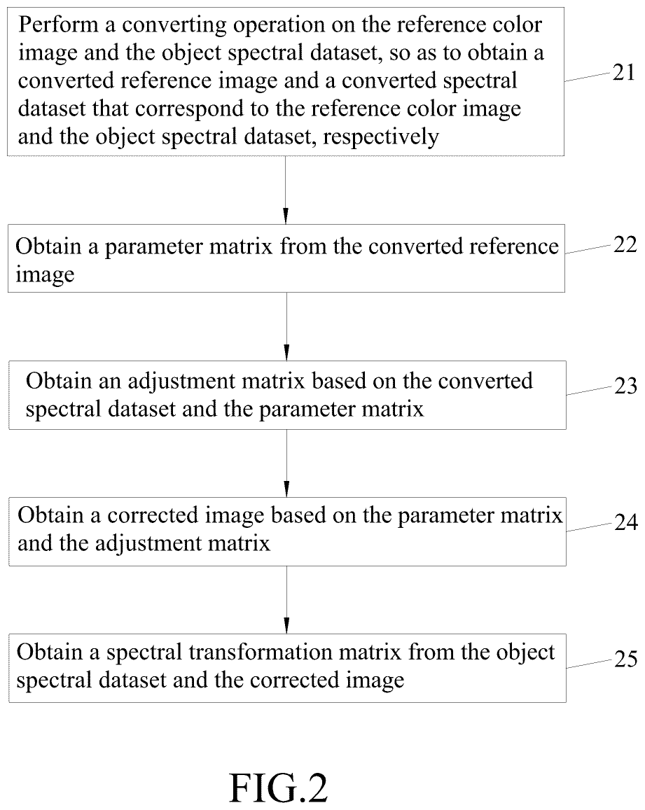

FIG. 2 is a flow chart illustrating steps of the matrix calculating process according to one embodiment of the disclosure. The matrix calculating process may be implemented by the processor 12 executing the software application program.

In step 21, the processor 12 performs a converting operation on the reference color image and the object spectral dataset to convert the same to a CIE 1931 XYZ color space created by the International Commission on Illumination (CIE) in 1931, so as to obtain a converted reference image and a converted spectral dataset that correspond to the reference color image and the object spectral dataset, respectively.

Specifically, the converting operation includes, with respect to the reference color image, obtaining the converted reference image using the following equations:

$$[ \begin{matrix}{X}_{C} \\ {Y}_{C} \\ {Z}_{C}\end{matrix} ] = [ {M}_{A} ] [ T ] [ \begin{matrix}f ( {R}_{sRGB} ) \\ f ( {G}_{sRGB} ) \\ f ( {B}_{sRGB} )\end{matrix} ] \times 100 , 0 \leq \begin{matrix}\begin{matrix}{R}_{sRGB} \\ {G}_{sRGB}\end{matrix} \\ {B}_{sRGB}\end{matrix} \leq 1 ;$$

$$[ T ] = [ \begin{matrix}0.4014 & 0.3576 & 0.1805 \\ 0.2126 & 0.7152 & 0.0722 \\ 0.0193 & 0.1192 & 0.9505\end{matrix} ] ;$$

$$f ( n ) = \{ \begin{matrix}{( \frac{n + 0.055}{1.055} )}^{2.4} , n > 0.04045 \\ ( \frac{n}{12.92} ) , otherwise\end{matrix} ; and$$

$$[ {M}_{A} ] = [ \begin{matrix}{X}_{SW} / {X}_{CW} & 0 & 0 \\ 0 & {Y}_{SW} / {Y}_{CW} & 0 \\ 0 & 0 & {Z}_{SW} / {Z}_{CW}\end{matrix} ]$$

where X_{C}, Y_{C} and Z_{C} respectively represent an X value, a Y value and a Z value of a pixel of the converted reference image in the CIE 1931 XYZ color space; R_{sRGB}, G_{sRGB} and B_{sRGB} respectively represent a red value, a green value and a blue value of a pixel of the reference color image in a standard red, green, blue (sRGB) color space, wherein the pixel of the reference color image corresponds to the pixel of the converted reference image; X_{CW}, Y_{CW} and Z_{CW} respectively represent a red value, a green value and a blue value of a white point that defines the white color in the sRGB color space and that is captured under the CIE standard illuminant D65, X_{SW}, Y_{SW} and Z_{SW} represent a white point for an environmental illuminant under which the reference color image was captured, and [M_{A}] represents a chromatic adaptation matrix. The white point is a set of tristimulus values or a set of chromaticity coordinates.

It is noted that, since the environmental illuminant used for capturing the reference color image may be one other than the standard illuminant in the sRGB color space, the chromatic adaptation matrix [M_{A}] is employed for converting the white point for the standard illuminant to a corresponding white point for the environmental illuminant of the reference color image.

The converting operation also includes, with respect to the object spectral dataset, obtaining the converted spectral dataset using the following equations:

X_{S}=k∫_{380 nm}^{780 nm}S(λ)R(λ)x̅(λ)dλ

Y_{S}=k∫_{380 nm}^{780 nm}S(λ)R(λ)y̅(λ)dλ

Z_{S}=k∫_{380 nm}^{780 nm}S(λ)R(λ)z̅(λ)dλ; and

k=100/∫_{380 nm}^{780 nm}S(λ)y̅(λ)dλ′

where, for each wavelength λ of the spectrum of the object spectral dataset (having a range from 380 to 780 nanometers), X_{S}, Y_{S} and Z_{S} respectively represent an X value, a Y value and a Z value of the converted spectral dataset in the CIE 1931 XYZ color space for the spectral value corresponding to the wavelength λ of the spectrum of the object spectral dataset, S(λ) represents a spectral value corresponding to the wavelength λ in a spectrum of the environmental illuminant under which the reference color image was captured, R(λ) represents the spectral value corresponding to the wavelength λ of the spectrum of the object spectral dataset, and x̅(λ), y̅(λ) and z̅(λ) represent color matching functions of the CIE 1931 XYZ color space.

It is noted that the converting operation as described above is performed in a pixel-to-pixel basis.

In step 22, the processor 12 obtains a parameter matrix from the converted reference image that was obtained in step 21.

Specifically, the parameter matrix is used to correct errors attributed to a number of factors that are related to the camera used to capture the reference color image. In this embodiment, the factors include a non-linear response of the camera, a dark current related to the camera, a deviation of a color filter of the camera, and a color shift of the camera (e.g., white balance (WB)). One or more matrices may be used to express correction parameters for correcting one or more of the above mentioned factors. Afterward, the parameter matrix may be obtained based on the one or more matrices for the above mentioned factors.

In this embodiment, a first matrix for the non-linear response of the camera may be expressed as

[V_{Non-linear}]=[X_{C}³Y_{C}³Z_{C}³X_{C}²Y_{C}²Z_{C}²X_{C}Y_{C}Z_{C}1]^{T}.

A second matrix for the dark current related to the camera may be expressed as [V_{Dark}]=[a], where a is a constant indicating the dark current, which is typically constant.

A third matrix for the deviation of the color filter of the camera and the color shift of the camera may be expressed as

[V_{Color}]=[X_{C}Y_{C}Z_{C}X_{C}Y_{C}X_{C}Z_{C}Y_{C}Z_{C}X_{C}Y_{C}Z_{C}]^{T},

where, since the reference color image has been converted to the CIE 1931 XYZ color space, the X, Y and Z values X_{C}, Y_{C} and Z_{C} of a pixel of the converted reference image are considered.

Using the above first to third matrixes, the parameter matrix is represented by:

[V]=[X_{C}³Y_{C}³Z_{C}³X_{C}²Y_{C}X_{C}²Z_{C}Y_{C}²Z_{C}X_{C}Y_{C}²X_{C}Z_{C}²Y_{C}Z_{C}²X_{C}Y_{C}Z_{C}X_{C}²Y_{C}²Z_{C}²X_{C}Y_{C}Z_{C}a]^{T}

In step 23, the processor 12 obtains an adjustment matrix based on the converted spectral dataset and the parameter matrix. Specifically, the adjustment matrix [C] is obtained by performing multiple regression analysis based on the following equation:

[C]=[XYZ_{Spectrum}]×pinv([V])

where [XYZ_{Spectrum}] is a matrix containing the X, Y and Z values of the converted spectral dataset in the CIE 1931 XYZ color space, [V] is the parameter matrix, and pinv([V]) represents an inverse matrix of the parameter matrix.

In step 24, the processor 12 obtains a corrected image based on the parameter matrix and the adjustment matrix. Specifically, the processor 12 obtains the corrected image using the following equation:

[XYZ_{Correct}]=[C]×[V]

where [XYZ_{Correct}] is a matrix containing X values, Y values and Z values of all pixels of the corrected image in the CIE 1931 XYZ color space. Using the above operation, the pixel values of the pixels that constitute the corrected image may be obtained, and the processor 12 is programmed to generate the corrected image accordingly.

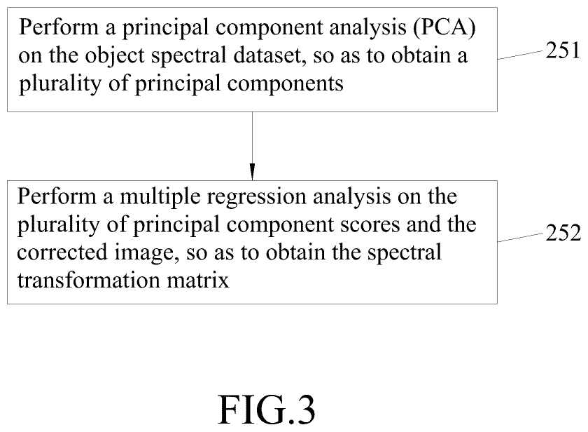

In step 25, the processor 12 obtains a spectral transformation matrix from the object spectral dataset and the corrected image. Specifically, FIG. 3 is a flow chart illustrating sub-steps of operations in step 25 according to one embodiment of the disclosure.

In sub-step 251, the processor 12 performs a principal component analysis (PCA) on the object spectral dataset, so as to obtain a plurality of principal components. Each of the principal components may include a principal component score and a principal component eigenvector.

Specifically, the PCA may be implemented using the following equation to obtain the principal component eigenvectors:

yⱼ=aⱼ₁(x₁ᵢ−x₁)+aⱼ₂(x₂ᵢ−x₂)+ . . . +aⱼₙ(xₙᵢ−xₙ)

where yⱼ represents a j^{th} one of the principal component eigenvectors, xₖᵢ represents a spectral intensity related to a k^{th} wavelength, xₖ represents an expected spectral intensity related to the k^{th} wavelength, and each of aⱼ₁ aⱼ₂, . . . aⱼₙ represents an eigenvector coefficient obtained by a covariance matrix.

In this embodiment, six principal component scores and six principal component eigenvectors of six principal components are obtained, as these principal component scores and principal component eigenvectors are capable of explaining 99.64% of variance within the object spectral dataset, but other numbers of principal component scores and principal component eigenvectors may be employed in other embodiments.

In sub-step 252, the processor 12 performs a multiple regression analysis on the plurality of principal component scores and the corrected image, so as to obtain the spectral transformation matrix.

Specifically, the operation of sub-step 252 includes using the following equation to obtain the spectral transformation matrix [M]:

[M]=[Score]×pinv([V′_{color}])

where [Score] is a matrix that contains the plurality of principal component scores, [V′ color]=[X_{C}′Y_{C}′Z_{C}′X_{C}′Y_{C}′X_{C}′Z_{C}′Y_{C}′Z_{C}′X_{C}′Y_{C}′Z_{C}′]^{T}, and X_{C}′, Y_{C}′ and Z_{C}′ respectively represent an X value, a Y value and a Z value of a pixel of the corrected image in the CIE 1931 XYZ color space.

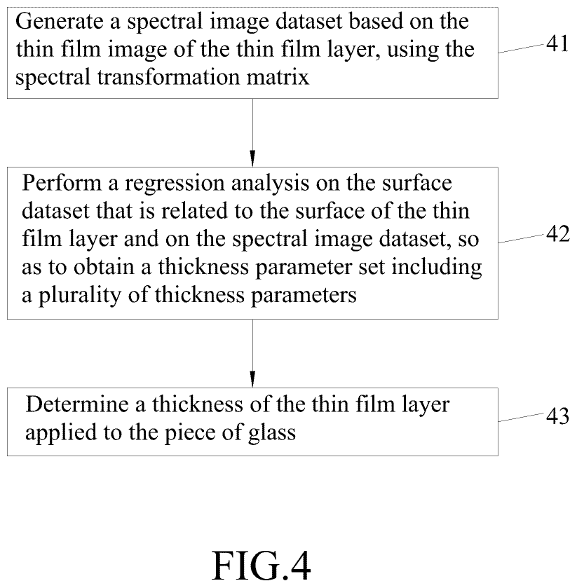

FIG. 4 is a flow chart illustrating steps of the measurement process according to one embodiment of the disclosure. In this embodiment, the measurement process is implemented using the processor 12 executing the software application program.

In step 41, the processor 12 generates a spectral image dataset based on the thin film image of the thin film layer, using the spectral transformation matrix. The spectral image dataset includes a plurality of entries of spectral data each related to a spectrum of a respective one of pixels of the thin film image. It is noted that while in this embodiment the thin film image is stored in the data storage medium 11, on other embodiments, the thin film image may be obtained from an external source via the communication unit 13.

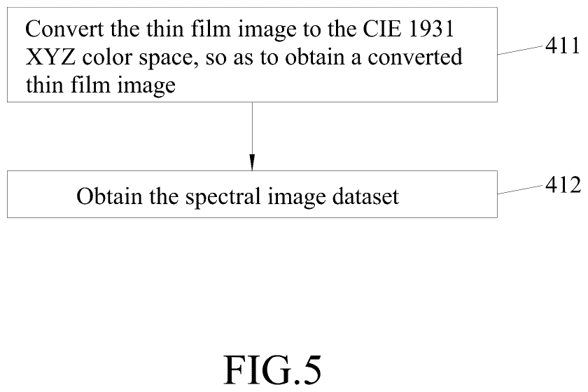

Specifically, FIG. 5 is a flow chart illustrating sub-steps of step 41 according to one embodiment of the disclosure.

In sub-step 411, the processor 12 converts the thin film image to the CIE 1931 XYZ color space, so as to obtain a converted thin film image. The operations of sub-step 411 may be done in a manner similar to step 21, and details thereof are omitted herein for the sake of brevity.

In sub-step 412, the processor 12 obtains the spectral image dataset using the following equation:

[S_{Spectrum}]=[EV][M][V_{Color}″]

where [S_{Spectrum}] is a matrix containing the plurality of entries of spectral data that are respectively related to the pixels of the thin film image, [M] is the spectral transformation matrix, [EV] is a matrix representing the principal component eigenvectors, and

[V_{Color}″]=[X_{T}Y_{T}Z_{T}X_{T}Y_{T}X_{T}Z_{T}Y_{T}Z_{T}X_{T}Y_{T}Z_{T}]^{T}

where X_{T}, Y_{T} and Z_{T} represent an X value, a Y value and a Z value of a pixel of the converted thin film image in the CIE 1931 XYZ color space, respectively.

After the spectral image dataset is generated, in step 42, the processor 12 performs a regression analysis on the surface dataset that is related to the surface of the thin film layer and on the spectral image dataset, so as to obtain a thickness parameter set including a plurality of thickness parameters.

In this embodiment, the regression analysis performed in step 42 is multiple regression analysis. It is noted that the implementation of multiple regression analysis has been well known in the related art (see, for example, U.S. Pat. No. 8,285,018), and details thereof are omitted herein for the sake of brevity.

In this embodiment, the plurality of reference parameter sets are also obtained using the operations of steps 41 and 42 in advance. Specifically, a plurality of pieces of glass, each with a thin film having a known thickness (i.e., a corresponding specific thin film thickness) disposed thereon, are prepared, and a thin film image of each of the plurality of pieces of glass is taken using the camera. The thin film images are then used to implement the operations of steps 41 and 42, so as to obtain a plurality of thickness parameter sets serving as the plurality of reference parameter sets. It is noted that in this embodiment, the thin film layer, the thickness of which is to be determined using the method, is made of a material that is the same as those of the thin films disposed on the plurality of pieces of glass, which correspond to the reference parameter sets.

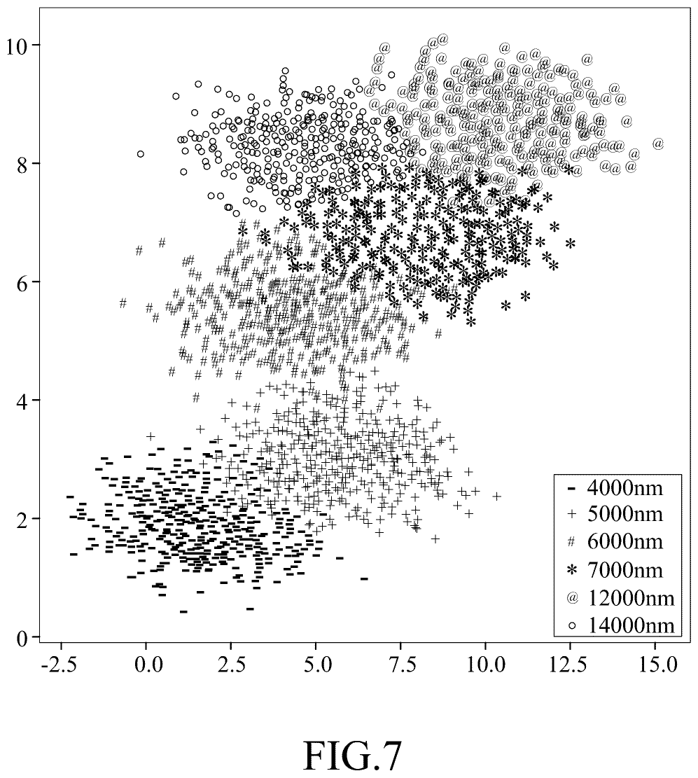

Then, the reference parameter sets may be processed by the processor 12 for later use. In one embodiment, the processor 12 is configured to scatter the reference parameter sets on a plot diagram as shown in FIG. 7.

In the example of FIG. 7, six different reference parameter sets are presented in the plot diagram, and each of the reference parameter sets is related to a thin film with a specific thickness (i.e., the reference parameters sets respectively correspond to thin film thicknesses of 4000 nm, 5000 nm, 6000 nm, 7000 nm, 12000 nm, 14000 nm). Each of the reference parameter sets has multiple data points scattered in the plot diagram. It is noted that with different materials or different thicknesses, the plurality of reference parameter sets may be different from the example shown in FIG. 7.

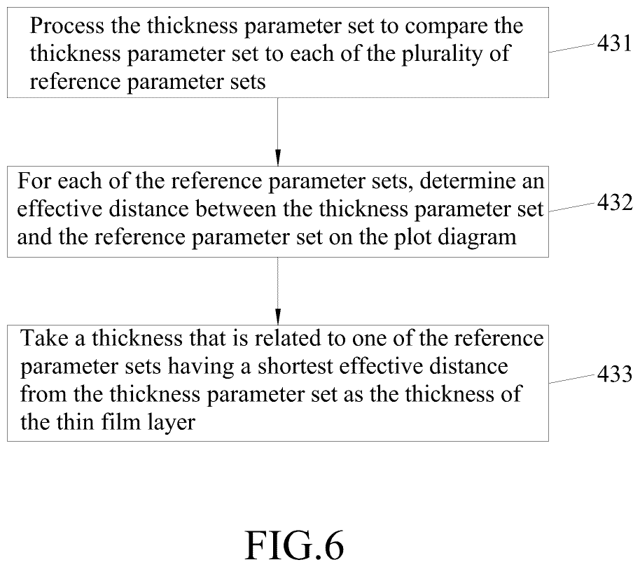

In step 43, the processor 12 determines a thickness of the thin film layer applied to the piece of glass, using the thickness parameter set obtained in step 42 and the plurality of reference parameter sets stored in the data storage medium 11. FIG. 6 is a flow chart illustrating the sub-steps of step 43.

In sub-step 431, the processor 12 processes the thickness parameter set to compare the thickness parameter set to each of the plurality of reference parameter sets. In this embodiment, the processor 12 may scatter the thickness parameter set on the plot diagram of FIG. 7. That is, the processor 12 may be configured to generate a plot diagram that includes both the thickness parameter set and the plurality of reference parameter sets. The thickness parameter set scattered in the plot diagram has multiple data points representing the thickness parameters, respectively.

Then, in sub-step 432, for each of the reference parameter sets, the processor 12 determines an effective distance between the thickness parameter set and the reference parameter set on the plot diagram. Specifically, the processor 12 may determine a central point for the thickness parameter set and a central point for the reference parameter set on the plot diagram, and calculate the effective distance as a distance between the central point of the thickness parameter set and the central point of the reference parameter set. For example, the central point is a geometric center of the distribution of the data points of the corresponding thickness/reference parameter set.

Then, in sub-step 433, the processor 12 takes a thickness that is related to one of the reference parameter sets having a shortest effective distance from the thickness parameter set as the thickness of the thin film layer.

To sum up, embodiments of the disclosure provide a method for measuring a thickness of a thin film layer disposed on glass. In the method, a thin film image of the thin film layer taken by a camera is used to generate a spectral image dataset, and multiple regression analysis is performed on a surface dataset associated with the surface of the thin film layer and the spectral image dataset, so as to obtain a thickness parameter set including a plurality of thickness parameters. Then, the thickness parameter set is compared with a plurality of reference parameter sets so as to determine the thickness of a thin film layer. In this manner, the thickness of the thin film layer may be measured without using invasive procedures to cut into the thin film layer, or conventional manual measurement. Also, the need to use a spectrometer (a relatively expensive equipment) may be eliminated.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is are considered the exemplary embodiments, it is understood that this disclosure is not limited to the disclosed embodiments but is intended to cover various arrangements included within the spirit and scope of the broadest interpretation so as to encompass all such modifications and equivalent arrangements.

What is claimed is:

1. A method for measuring thickness of a thin film layer on a piece of glass, the method being implemented using a computer device that includes a processor and a data storage medium storing a thin film image of the thin film layer taken by a camera, a surface dataset related to a surface of the thin film layer, and a plurality of reference parameter sets each being related to a specific thin film layer thickness, the method comprising following steps:
A) generating a spectral image dataset that includes a plurality of entries of spectral data based on the thin film image of the thin film layer using a spectral transformation matrix, each of the entries of spectral data being related to a spectrum of a respective one of pixels of the thin film image;
B) performing regression analysis on the surface dataset and the spectral image dataset, so as to obtain a thickness parameter set including a plurality of thickness parameters; and
C) determining the thickness of the thin film layer using the thickness parameter set and the plurality of reference parameter sets.

2. The method of claim 1, the computer device storing a reference color image of a reference object that is taken by the camera and an object spectral dataset that is associated with the reference object, the method further comprising, prior to step A), following steps:
D) performing a converting operation to convert the reference color image and the object spectral dataset to a CIE 1931 XYZ color space created by the International Commission on Illumination (CIE) in 1931, so as to obtain a converted reference image and a converted spectral dataset that correspond to the reference color image and the object spectral dataset, respectively;
E) obtaining a parameter matrix from the converted reference image;
F) obtaining an adjustment matrix from the converted spectral dataset and the parameter matrix;
G) obtaining a corrected image based on the parameter matrix and the adjustment matrix; and
H) obtaining the spectral transformation matrix from the object spectral dataset and the corrected image.

3. The method of claim 2, wherein step H) includes:
performing principal components analysis (PCA) on the object spectral dataset, so as to obtain a plurality of principal component scores; and
performing multiple regression analysis on the plurality of principal component scores and the corrected image, so as to obtain the spectral transformation matrix.

4. The method of claim 1, wherein step A) includes:
converting the thin film image to a CIE 1931 XYZ color space created by the International Commission on Illumination (CIE) in 1931, so as to obtain a converted thin film image; and
obtaining the spectral image dataset using the following equation:
[S_{Spectrum}]=[EV][M][V_{Color}″]
where [S_{Spectrum}] is a matrix containing spectral data that is associated with different pixels of the thin film image, [M] is the spectral transformation matrix, [EV] is a matrix representing a plurality of principal component eigenvectors, and
[V_{Color}″]=[X_{T}Y_{T}Z_{T}X_{T}Y_{T}X_{T}Z_{T}Y_{T}Z_{T}X_{T}Y_{T}Z_{T}]T
where X_{T}, Y_{T} and Z_{T} represent an X value, a Y value and a Z value of a pixel of the converted thin film image in the CIE 1931 XYZ color space, respectively.

5. The method of claim 1, wherein step C) includes:
processing the thickness parameter set to compare the thickness parameter set and the plurality of reference parameter sets;
determining an effective distance between the thickness parameter set and each of the plurality of reference parameter sets;
taking, as the thickness of the thin film layer, one of the specific thin film thicknesses that is related to a selected one of the reference parameter sets, wherein the selected one of the reference parameter sets has a shortest effective distance from the thickness parameter set among the reference parameter sets.

6. The method of claim 1, wherein in step B), the regression analysis is multiple regression analysis.
